(19) United States
(12) Patent Application Publication
(10) Pub. No.: US 2020/0170083 A1
(43) Pub. Date: May 28, 2020

(54) SYSTEMS AND METHODS FOR CENTRALIZED REMOTE CONTROL OF HEATERS

(71) Applicant: GOJI LIMITED, Hamilton (BM)

(72) Inventors: Ben ZICKEL, Qiryat Bialik (IL); Ram ELBOIM, Modiin (IL); Lior DARSHAN, Rishon LeZion (IL); David SHECHTER, Raanana (IL); Zalman IBRAGIMOV, Rehovot (IL)

(73) Assignee: GOJI LIMITED, Hamilton (BM)

(21) Appl. No.: 16/611,381

(22) PCT Filed: May 6, 2018
(86) PCT No.: PCT/IL2018/050493

§ 371 Date: Nov. 6, 2019

Related U.S. Application Data
(60) Provisional application No. 62/502,686, filed on May 7, 2017.

(51) Int. Cl. H05B 6/68; H05B 6/64; H05B 6/66; A23L 5/10

(52) U.S. Cl. CPC H05B 6/686; H05B 6/6447; A23V 2002/00; A23L 5/15; H05B 6/668

(57) ABSTRACT

There is provided a method for monitoring and control of heating food portions in heaters, each installed in communication with a respective client computer in communication with a same server, the method performed by the server comprising: receiving from the client computers, RF signatures, each RF signature being based on measured reflections of RF signals transmitted within a cavity of one of the heaters containing therein a food portion, analyzing the RF signatures, determining for each heater based on the analysis of the RF signatures, at least one heating instruction to operate each heater to heat the food portion therein; and transmitting to each of the client computers, the respective at least one determined heating instruction comprising instructions to generate RF signals and transmit the RF signals to the food portions using heating antennas of the heater.

The present application claims the benefit of priority to U.S. Provisional Patent Application No. 62/502,686 filed on May 7, 2017, which is incorporated herein in its entirety.

### BACKGROUND

The present invention, in some embodiments thereof, relates to systems and methods for control of heaters and, more specifically, but not exclusively, to systems and methods for centralized control of heaters, which may be heaters.

A heater heats and cooks food by application of electromagnetic energy in the microwave frequency range to a resonator cavity having the food therein.

Heaters tend to heat food quickly while using less energy compared to a standard oven, but are difficult to control to achieve a desired heating result by a user. For example, users may stop the heating process multiple times to check the status of the food. Moreover, heaters tend to heat foods unevenly, which may make it difficult to cook foods in a heater. For example, frozen foods may cook at certain parts while other parts remain frozen.

### SUMMARY

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

An aspect of some embodiments of the invention includes a computer-implemented method for monitoring and control of heating food portions in a plurality of heaters, each installed in communication with a respective client computer, wherein the client computers are in communication with a same server. The method comprises:

receiving at the server, from the client computers, RF signatures, each RF signature being based on measured reflections of a plurality of RF signals transmitted within a cavity of one of the heaters, the cavity containing therein a food portion to be heated by the respective heater;

analyzing, by the server, the RF signatures received from the client computers;

determining for each heater, by the server and based on the analysis of the RF signatures, at least one heating instruction to operate each heater to heat the food portion therein; and

transmitting, from the server to each of the client computers, the respective at least one heating instruction determined for the respective heater.

In some embodiments, the heaters are dielectric heaters.

In some embodiments, each heating instruction comprises an instruction to generate a plurality of RF signals and transmit the plurality of RF signals to the food portions using heating antennas of the dielectric heater. In some such embodiments, each of the plurality of RF signals has a power of at least 100 W.

In some embodiments, the analysis comprises comparing the RF signature with RF signatures received by the server from a plurality of client computers, each in communication with a respective heater.

In some embodiments, determining the at least one heating instruction comprises selecting the at least one heating instruction from a plurality of heating instructions.

In some embodiments, the analysis of the RF signatures is performed by a member selected from the group consisting of:

a classifier trained on RF signatures obtained by a plurality of client computers, each in communication with a respective heater;

a regression function modeling RF signatures obtained by a plurality of client computers, each in communication with a respective heater;

matching the received RF signature to an entry in a look-up table storing RF signatures obtained by the plurality of client computers; and

associating the received RF signature to one of the RF signatures stored in a database according to statistical similarity, wherein the RF signatures stored in the database are obtained by the plurality of client computers.

In some embodiments, determining the at least one heating instruction comprises determining at least one heating instruction to operate the heater to at least one of:

reduce relative total energy consumption of heating the food portion during heating; and

improve heating effectiveness of the food portion during heating in comparison to a locally stored standard heating program executed by the client computer without server input.

In some embodiments, the instructions to generate a plurality of RF signals include instructions to generate RF signals that differ from one another in at least one of frequency and phase.

In some embodiments, the analysis of the RF signatures comprises:

applying a classifier to the RF signature to classify the food portion into a heating category from a plurality of heating categories each associated with a corresponding heating instruction; and

selecting a heating instruction for the food portion based on the classification.

In some embodiments, the method further comprises:

controlling by the server the heating of the food portions. The controlling may be, for example, by:

iterating the receiving and the analyzing, and wherein determining comprises receiving data indicative of results of measurements of reflections of RF signals;

adjusting the at least one heating instruction according to results of the analyzing to generate an adjusted heating instruction; and

transmitting the adjusted heating instruction to the client computer to operate the heater according to the adjusted heating instruction.

In some embodiments, the method further comprises:

controlling by the server the heating of the food portions, by:

iterating the receiving and the analyzing, and wherein determining comprises receiving data indicative of results of measurements of reflections of the RF;

adjusting the heating instruction according to results of the analyzing to generate an adjusted heating pattern; and

transmitting the adjusted heating pattern to the client computer to operate the heater to generate RF signals according to the adjusted heating pattern.

In some embodiments, the heating instructions adjusted according to a heating target.

In some embodiments, the controlling is performed in real-time.

In some embodiments, the method further comprises transmitting instructions to generate RF signals according to the adjusted heating pattern for a predefined period of time, and repeating the controlling upon expiration of the predefined period of time.

In some embodiments, the controlling is repeatedly performed during a cooking process of the food portion.

In some embodiments, the method further comprises:

receiving at the server, from each of the client computers, an indication of whether a desired heating effect is reached;

associating with each of the received RF signature data, at least one heating instruction sent from the server to operate the respective heater, and an associated indication of whether the desired heating effect is reached using the at least one heating instruction; and

training a classifier that performs the determining of the at least one heating instruction according to the indication of desired heating effects.

In some embodiments, the method further comprises training the classifier using RF signature data as input into the classifier and corresponding applied heating instructions as output of the classifier.

I some embodiments, the method further comprises::

aggregating, at the server, RF signature data and an indication of a current state of the food portion received from at least some of the client computers; and

training a classifier to perform the analysis using the RF signature data representing input into the classifier and the current state of the food portion as a categorization representing output by the classifier. In some embodiments, the current state of the food comprises a type of food.

In some embodiments, the method further comprises:

aggregating, at the server, test results of a self-test executed by at least one of the client computers to test the respective heater;

grouping the test results according to types of heaters; and

analyzing the test results according to the grouped types of heaters to determine service requirements.

In some embodiments, the method further comprises:

aggregating adjusted heating patterns and respective measured reflections of the applied heating instructions, at the server, from the plurality of client computers associated with respective heaters, to update a trained classifier that adjusts at least one heating instruction based on received measured reflections.

In some embodiments, the method further comprises:

determining a hardware-type of each heater;

receiving RF signature data from at least one of each heater; and

determining the at least one Heating instruction for each heater according to the hardware-type of the heater and the received RF signature data aggregated from the respective heater.

In some embodiments, the method further comprises:

receiving, at the server, from each of a plurality of client computers, a dish indication, indicative of a dish being heated by a respective heater in communication with a respective client computer, by a respective user using the respective heater;

creating a user profile for each user based on a set of dish indications; and

associating different user profiles into common profiles according to dish indications that are common across the set of dish indications of the user profiles. Optionally, this method further comprises:

receiving, at the server, an indication that a new dis is heated by a certain user of a certain user profile;

identifying the common profile associated with the certain user;

accessing the common profile to obtain another at least one dish; and

transmitting, for presentation to the client computer, the obtained another at least one dish.

In some embodiments, the method further comprises:

determining at least one cooking parameter for the dish indication;

including the at least one cooking parameter determined for the dish indication in the user profile; and

wherein associating comprises associating different user profiles with common profiles according to cooking parameters of dish indications that are common between user profiles.

In some embodiments, the at least one cooking parameter includes one or more members selected from the group consisting of: a total cooking time of the dish indication, a cooking temperature of the dish indication, a time of day when the dish indication is cooked, a day of the week when the dish indication is cooked, a holiday when the dish indication is cooked, a date when the dish indication is cooked, and a geographic location where the dish indication is cooked.

In some embodiments, the heater includes or is in communication with a non-RF heating element; wherein determining further comprises: determining at least one non-RF heating instruction for application by the non-RF heating element, in association with the determined RF heating instruction. Optionally, the non-RF heating instructions includes instructions to use convection heating.

In some embodiments, the method further comprises performing an initialization by:

receiving, at the server, data indicative of the RF signals whose reflections were used to measure the RF signature, the RF signals including data for calculating a phase difference between at least two of the RF signals;

calculating the phase difference; and

transmitting instructions to adjust the RF signals such that the calculated phase difference approaches a target phase value.

In some embodiments, the method further comprises, before the act of receiving RF signature data:

receiving, at the server, from the client computer, an initialization signature indicative of the presence of a food portion ready to be heated in the heater in communication with the client computer;

transmitting, from the server to the client computer, instructions to:
measure reflections of a plurality of RF signals transmitted within a cavity of the heater, the cavity containing therein the food portion;
send to the server an RF signature based on the reflections measured; and
associating the RF signature with the received initialization signature.

An aspect of some embodiments of the invention includes a computer-implemented method for monitoring and control of heating food portions in a heater installed in communication with a client computer, wherein the client computer is in communication with a server, the method comprising:

transmitting, to the server, from the client computer, an RF signature based on measured reflections of a plurality of RF signals transmitted within a cavity of the heater, the cavity containing therein the food portion;

receiving, from the server, at least one heating instruction determined by the server based on analysis of the RF signature, to operate the heater to heat the food portion, the at least one heating instruction comprising instructions to generate a plurality of RF signals and transmit the plurality of RF signals to a cavity of the heater; and

controlling the heater according to the received at least one heating instruction.

In some such embodiments, this method further comprises:

detecting, by the client computer, a failure to receive an instruction message from the server defining the heating instruction for an upcoming period of time; and

continuing, by the client computer, to control the heater to heat according to the previously received heating instruction.

In some embodiments, this method further includes:

monitoring, by the client computer, for reception of the instruction message for a predefined time requirement; and

upon expiration of the predefined time requirement, applying a heating instruction according to instructions locally stored on a storage medium of the client computer of the heater.

An aspect of some embodiments of the invention includes a server for monitoring and control of heating food portions in a plurality of heaters, each installed in communication with a respective client computer, each food portion contained within a cavity of the respective heater, the server comprising:

a communication interface for communicating using a network with the plurality of client computers;

a program store storing code; and

a processor coupled to the communication interface and the program store for implementing the stored code, the code comprising:

instructions to:
receive RF signatures from each of the client computers, each RF signature being based on measured reflections of a plurality of RF signals transmitted within each respective cavity;
analyze each RF signature;
determine, based on the analysis of the RF signatures, at least one heating instruction to operate the respective heater to heat the respective food portion; and
transmit each determined at least one heating instruction to the respective client computer.

wherein the determined at least one heating instruction comprises instructions to generate a plurality of RF signals and transmit the plurality of RF signals to a cavity of the respective heater.

In some embodiments, the determined at least one heating instruction comprises instructions to generate a plurality of RF signals and transmit the plurality of RF signals to a cavity of the respective heater.

An aspect of some embodiments of the invention includes a computer-implemented method for monitoring and control of heating food portions in a heater installed in communication with a client computer, wherein the client computer is in communication with a server, the method comprising:

receiving at the server, from the client computer, an RF signature based on measured reflections of a plurality of RF signals transmitted within a cavity of the heater, the cavity containing therein the food portion;

analyzing, by the server, the RF signature received from the client computer;

determining by the server, based on the analysis of the RF signatures, at least one heating instruction to operate the heater to heat the food portion; and

transmitting, from the server to the client computer, the determined at least one heating instruction.

In some embodiments, the determined at least one heating instruction comprising instructions to generate a plurality of RF signals and transmit the plurality of RF signals to the food portions using heating antennas of the heater.

In some embodiments, the heater is one of a plurality heaters, each installed in communication with a respective client computer, and all the client computers are in communication with the server.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for centralized monitoring and control of heating food portions heated by respective heaters, in accordance with some embodiments of the present invention;

FIG. 2A is a block diagram of a system that includes a central server that determines Heating instructions for multiple network connected client computers each installed in association with a heater, in accordance with some embodiments of the present invention;

FIG. 2B is a block diagram depicting exemplary internal components of the server, client computers, and heater, in accordance with some embodiments of the present invention;

FIG. 3 is a flowchart of a computer-implemented method that trains a classifier to determine the Heating instruction for a heater, in accordance with some embodiments of the present invention;

FIG. 4A is a flowchart of a computer-implemented method that aggregates data from multiple users, in accordance with some embodiments of the present invention;

FIG. 4B is a flowchart of a computer-implemented method that provides personal recommendations to a user based on data aggregated from multiple users, in accordance with some embodiments of the present invention;

FIG. 5 is a flowchart of a computer-implemented method for monitoring and/or control of heating food portions in a heater, in accordance with some embodiments of the present invention; and

FIG. 6 is a diagrammatic illustration of another exemplary implementation based on the system of FIG. 2B, in accordance with some embodiments of the present invention.

### DETAILED DESCRIPTION

The present invention, in some embodiments thereof, relates to systems and methods for control of heaters and, more specifically, but not exclusively, to systems and methods for centralized control of heaters. In some embodiments, the heaters are dielectric heaters, that is, heaters configured to heat the object to be heated by transmitting electromagnetic radiation in the microwave frequency range into a microwave cavity resonator holding the object to be heated. In some embodiments, the heaters heat by heating the air around the object to be heated and/or by convection of hot air around the object to be heated. In some embodiments, the heaters may include IR heaters, heating by radiating IR radiation to the object, induction heaters, inducing currents in metallic plates on which the object to be heated lies, or any other kind of heater known in the art.

An aspect of some embodiments of the present invention relates to a server in network communication with multiple client computers each installed in communication with a heater. The server provides control services to multiple client computers, each in communication with a respective heater. In some embodiments, the server is dedicated to serving heaters, as described herein. In some embodiments, the server may provide services to additional clients, related or nonrelated to the present disclosure. The heater may be a microwave oven. In some embodiments, the heater comprises a microwave heater and/or other kind of heater or heaters, for example, convection heater, IR heater, and/or induction heater. An aspect of the some embodiments of the present invention relates to a method (e.g., implemented by the server) of centrally monitoring and/or controlling heating of food portions in heaters, each connected to a client computer connected to the server. For example, the server may receive, from each client computer, RF signature(s). The RF signatures are data-sets indicative of measured reflections of RF signals transmitted within the respective cavity of the heater containing the food portion. The RF signature is analyzed by the server to determine heating instruction(s) to operate the heater and heat the food portion. An heating instruction may include, for example, instructions how to apply RF energy to the cavity from which the RF signature was received, to what temperature air in the cavity is to be heated, at what speed air is to be conveyed to the cavity, etc.. In embodiments that apply heat by RF heating, the RF signatures may be obtained by reading reflections of signals that are also used for heating. In some embodiments, however, RF may be used for heating, and still, the RF signature is obtained from signals of lower power, so that the signature may be obtained without heating the object. In some embodiments, where RF energy is not used for heating, a heater includes RF system for generating the signatures. Such a system may be configured to supply RF energy only at low power levels, which are sufficient for collecting the signatures, e.g., between about 1 and 100 mW.

For example, instructions how to heat by RF energy (also referred to herein as RF heating pattern) for heating in a dielectric heater may include instructions at what frequencies to apply the energy, at what power levels, and for how long. The power levels and/or duration lengths may be frequency dependent. The RF heating pattern may also include instructions to apply the energy in a certain order. RF heating pattern may include, instead of or in addition to frequencies, phase differences. For example, if an RF heating device is configured to heat by coherent radiation emitted by two antennas, an RF heating pattern may include instructions to transmit RF radiation at specific phase differences between signals emitted by the two antennas. Similarly, RF heating pattern may include, instead of or in addition to frequencies and/or phase differences, amplitude ratios. For example, if an RF heating device is configured to heat by coherent radiation emitted by two antennas, a ratio between the amplitude of signals emitted by the two antennas may be provided by the RF heating pattern. The RF heating pattern may be represented, for example, as values of heating parameters for operating the dielectric heater, as compiled code executed by the heater, as a script, as a non-compiled program, or other implementations of instructions.

Heating instructions for a convection heater may include, for example, air temperature, air speed, nozzles from which air is to be conveyed to the heater's cavity, heating length, periods for which no heating is applied, periods for which air is not circulated around the object, etc. In some embodiments, dielectric and non-dielectric heating systems are provided in one or more of the heaters. Such a heater may be referred to herein as a combi heater. Heating instructions to a combi heater may include instructions as to the order at which the different heating systems provided in the combi heater. For example, the heating instructions may include instructions when to start and when to stop each of the heating systems, e.g., the dielectric heating system, the convection heating system, the induction heating system, the IR heating system, etc.

Optionally, the server dynamically monitors and controls the heating of the food portion in real-time during the cooking process. As used herein, the term real-time means that the server receives data from the client computers representing the current status of the food being heated, processes the data, and transmits instructions to the respective client computers quickly enough to respond to the current status of the food before statistically significant changes have occurred to the food as a result of heating during the delay incurred from the server. For example, real time heating control may include controlling a change in the heating within less than about 0.5 seconds, or 1 second, or 3 seconds, or 5 seconds, from the instant a decision that a change in heating instructions is considered.

A heating target, for example, temperature, food consistency, water content, may be selected for the food portion. The food portion may be indicated by being manually entered by the user, for example, entered using a user interface, for example, a touch-screen, or a keypad.

Data indicative of the results of measurements of reflections measured during the execution of the instructions included in the heating instructions is analyzed. The results of the measurements of the reflection may be analyzed in view of the heating target to determine an adjusted heating instruction, and/or adjust the determined heating instruction. The data may represent a current state of the food portion being heated, which may be compared to the heating target. The adjusted heating instruction may be transmitted by the server to the respective client computer to operate the heater.

An aspect of some embodiments of the present invention relates to a server in network communication with multiple client computers. Each one of the client computers is installed in communication with a respective heater (e.g., microwave oven, convection oven, combi oven, etc.). The server may determine, for each one of the heaters a heating instruction. The determination of a heating instruction for a heater may be carried out based on a dataset aggregated from multiple other heaters, for example, by a trained classifier. In some embodiments, the server receives an RF signature from a heater, and determines the heating instruction to operate the respective heater to heat the food portion. The determination may be based on the dataset that includes data aggregated from multiple other heaters.

The determining of the heating instruction by the server may be performed, for example, by selecting from among available heating instructions, and/or by calculating the heating instruction. The selection from available heating instructions may be performed, for example, by a classifier that maps the received RF signature to the heating instruction.

For example, the dataset may allow selection of heating instructions which have had good results in heating similar food portions in other similar heaters. The client-server architecture allows the server to aggregate data from multiple client computers, and to centrally analyze the data to create the dataset, for example, by centrally training and/or updating a classifier.

Optionally, the heating instruction is selected to improve the heating effectiveness of the food portion. The heating effectiveness may be associated with food portions and/or with heating instructions, and used to train a classifier that selects the best heating instruction.

Heating effectiveness may be indicative of conformity between desired and established heating results. For example, in some embodiments, users may be prompted to report how they consider the heating quality, without referring to any objective aspect of the heating. In some embodiments, in response to such prompting, users are enabled to grade the cooking by one of several grades, e.g., good, acceptable, or bad. In some embodiments, the user may initiate providing the feedback without being prompted to do so, for example, by pressing a “provide feedback” button. In addition, or as an alternative, information on data effectiveness may be more specific. For example, in some embodiments, the users are allowed to share (e.g., through a user interface) their view regarding more specific qualities of the cooking process, for example, how uniform the heating was; was it sufficiently fast, was the food cooked to the desired degree, etc. Heating effectiveness may be indicative of the total energy consumption to achieve the desired heating results, which may be relatively reduced compared to established heating results, for example, using less electricity to achieve the desired heating result as compared to established heating results.

The parameters indicative of the heating effectiveness may be manually entered by users using a user interface, and/or automatically measured and/or calculated by the client computers.

Optionally, indications of whether a desired heating effect is reached using the determined heating instruction are aggregated from the client computers, for example, manually entered by the user using a physical user interface and/or automatically measured by a client computer. In some embodiments, the RF signature data, the determined heating instruction, and the aggregated indications of heating effectiveness are used to train a classifier to determine for different RF signatures the heating instruction that provides the most satisfactory results.

Optionally, the classifier is trained and/or updated using an indication of the current state of the food. A state of a food may include, for example, the food temperature, degree of doneness, degree of freezing/defrosting, etc. The current state of the food may be determined by the server, for example, based on manually entered data, entered by the user using a physical user interface, for example, a keypad, a touchscreen, or a barcode reader. In another example, the current state of the food may be automatically calculated by code based on one or more sensor measurements, for example, temperature measured by a thermometer. The classifier may be used to dynamically control the heating process, by dynamically selecting adjusted heating instructions (or adjusting the selected heating instructions) according to the current state of the food and/or according to the current RF signature, optionally to try and reach a desired state of the food.

The classifier may be trained to determine the heating instruction according to the hardware-type of each heater. Devices of different hardware-types may differ from each other, for example, in the kind of heating provided, in one or more of the cavity volume, etc.

In some embodiments, the classifier may be trained to analyze test results of a self-test executed by the client computers to test the heater, and determine service requirements according to the test results.

Optionally, the server creates a user profile for each user based on a set of indications of dishes being heated by the respective user using a heater. The heating may be, for example, for cooking, or defrosting. In some embodiments, the user profile may be associated with a specific client computer. In some embodiments, for example, when multiple users use the same heating device, one client computer may be associated with multiple user profiles. The users can identify themselves before starting a session of heating, for example, for cooking. The server optionally clusters different user profiles to create common profiles representing dish indications that are prepared frequently by the users whose profiles are clustered into the common profile.

For example, one common profile may include profiles that include frequent users of the heater for preparing beef, pork, and poultry, and another common profile may include profiles of users that use the heater for preparing mainly dairy dishes. For a user heating a new dish, the server may access a common profile associated with the new dish indication to identify other dish indications that the user may enjoy. For example, a user that prepares a cheese cake may be suggested to prepare also a cheese pie. The other dish indication is transmitted to the client computer of the user for presentation to the user, for example, within a graphical user interface presented on the display of the client computer, or a message sent to another computing device of the user (e.g., Smartphone). In some embodiments, the suggestion is sent to the users automatically. In some embodiments, the suggestion is sent to the user in response to a user request for recommendations for new dish indications.

The systems and/or methods described herein relate to the technical problem of improving the process of determining a heating instruction (and/or cooking pattern, and/or baking pattern, and/or other effects of administering RF energy or other kinds of energy to a food portion) for operating a heater heating a food portion located in a cavity of the heater. The heating instruction is determined to improve effectiveness of heating (e.g., heat the food portion relatively more evenly, for example, avoid cooking some parts while other parts remain frozen) and/or improve energy efficiency of achieving a heating target (e.g., reduce total energy consumption required to reach the heating target).

The systems and/or methods described herein relate to a server in communication over a network with multiple client computers each installed in communication with a respective heater. As such, the systems and/or methods described herein are tied to computer technology, and/or to heating technology. In particular, the systems and/or methods described herein improve the process of heating a food portion in a cavity of a heater (optionally to a desired heating target) by analyzing received RF signatures, determining and/or adjusting a heating instruction, and monitoring the effects of the heating instruction.

The client-server architecture of the system described herein (and/or of the system implementing the methods described herein) improves performance of the client computers, the server, and/or the network. Methods executed by the server may be centrally updated, affecting the heaters receiving services. For example, methods for selecting the heating instruction, and/or methods for training the classifier for selection of the heating instruction may be improved and centrally updated, for example, instead of having to update each heater, which reduces network traffic and/or improves processor and/or memory resource utilization. Updates may be performed without involving users of the heaters. Relatively fewer computation resources (e.g., processors, memory) may be required at each site (i.e., the set of client computer and heater), while providing computationally complex services by the server, for example, expanded memory storage space and more powerful processing ability may be installed at the server compared to the client computers. In this manner, the cost of each client computer and/or heater may be relatively low (due to the reduced resource requirements), while still providing the computationally complex service remotely by the server.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention.

In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the terms heating and cooking (and other terms used to describe effects of administering heat energy to food in a heater) are sometimes interchangeable.

As used herein, the terms dielectric heating, RF heating, and microwave heating, are used as synonyms, and mean heating by electromagnetic radiation other than by induction or by infrared (IR), and in some embodiments, heating by electromagnetic radiation at frequencies of 300 MHz to 6 GHz, and particularly heating by radiation at frequency bands allowed by regulatory authorities for industrial, scientific, and medical uses, also known as ISM bands. For example, RF energy may in some embodiments be limited to heating with frequencies only of one or more recognized ISM bands, for example: between 433.05 MHz and 434.79 MHz; between 902 MHz and 928 MHz; between 2.4 GHz and 2.5 GHz; and between 5.725 GHz and 5.875 GHz.

As used herein, the term RF signature relates to a measurement result of signals received at the antennas of the heater when (other) signals are transmitted by the antennas. The measurement result may be indicative of the electrical reaction of the cavity with the food portion therein to the transmitted signals. The signature may be multi-dimensional in the sense that the transmitted signals may define several dimensions (for example, when all the antennas transmit at the same frequency and different phases, and the measurements are the power received by each of the N antennas, one may have an RF signature of N(N-1) dimensions. (N received powers and N-1 phase differences). When the signature includes M frequencies, the signature may be of dimension MN(N-1). When the measurement is not of power received at each antenna but rather of amplitudes and phases of signals received at each antenna, the dimensionality may become 2MN(N-1). The signals transmitted to obtain the RF signatures may be of the same frequencies as RF used for heating, but in some embodiments, the RF signatures are not limited to ISM bands, since signature measurement can be carried out at very low power levels (e.g., between 1 mW and 100 mW), and it may be easy and cheap to ensure that radiation does not escape the cavity at such low power levels. Power levels used for heating are of the order of hundreds of Watts (typically between 100W and 1000W).

As used herein, the term code means instructions stored on a non-transitory computer-readable medium executed by a processor, for example, a compiled program, a script (e.g., text), a non-compiled program, binary code, and other instruction formats.

Examples of measurements that may be used to represent the RF signature include measurements of S parameters and of F (gamma) parameters.

S parameters are measured when one antenna transmits and all the other antennas are silent. The S parameter represents the ratio between signal received at an antenna and signal transmitted through the transmitting antenna. The magnitude is represented as a value between zero and one, since each signal measured to be received at an antenna is at most as large as the original signal transmitted into the cavity of the dielectric heater.

It is noted that the signal ratio may be a complex number, having a real part that is the ratio between the magnitudes of the signals, and an imaginary part, that is the difference between the phases of the signals.

Γ parameters are measured when two or more of the antennas transmit simultaneously, representing the ratio between signal received and sent at the same antenna. Γ parameters may be larger than 1, because the antenna where the parameter is measured is not necessarily the only one transmitting at the time of measurement.

Dissipation ratio (DR) denotes the ratio between power dissipated in the cavity (including the object to be heated, cavity walls, plates) and power inputted into the cavity. The dissipated power may be approximated by the difference between power measured to be inputted into the cavity and power measured to go out of the cavity

$$DR = \frac{{P}_{in} - {P}_{out}}{{P}_{in}} = 1 - \frac{{P}_{out}}{{P}_{in}} \frac{{P}_{out}}{{P}_{in}}$$

is sometimes referred to as loss.

The RF signature may be a graph of loss or DR vs. frequency (e.g., when only one antenna is used), or vs. frequency and phase combination (when two or more antennas are used coherently). Alternatively or additionally, the RF signature may include the S parameters, the F parameters or any other parameter indicative of the electrical response of the cavity to the incoming RF signals, as function of the setup at which the incoming signals were excited (also referred to herein as an excitation setup). The excitation setup may include frequency, phase combination, amplitude combination (e.g., if different antennas transmit at different amplitudes simultaneously), or any other parameter, controllable by the apparatus, that may affect the field pattern excited in the cavity (also referred to herein as controllable field affecting parameter, c-FAP in acronym).

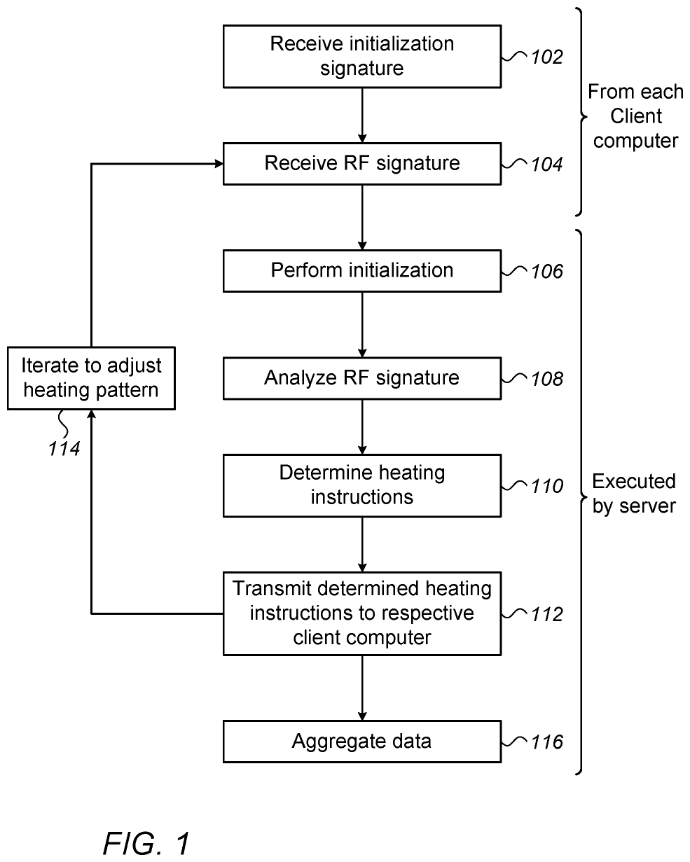

Reference is now made to FIG. 1, which is a flowchart of a method (e.g., implemented by a server) for centralized monitoring and control of heating food portions each being heated by a heater installed in communication with a server, in accordance with some embodiments of the present invention. A server implementing the method determines heating instructions for operating the heater based on an analysis of RF signatures received from the respective client computers.

The method is based on two types of control implemented by the server based on data transmitted from the client computers. One type analyzes RF signatures (i.e., measurements based on reflections within the heater) to decide how to continue with the heating. For example, if heating is performed only by radio frequencies that have high DR values, the server identifies these frequencies, and transmits instruction to the client computer to operate the dielectric heating device to use only the defined frequencies for heating. Another type of control that may be implemented by the server, is to ensure that the instructions transmitted to the client terminal are being accurately fulfilled. For example, that when the server decided to heat at a certain phase difference and/or amplitude, the heating actually occurs at the certain phase difference and/or amplitude.

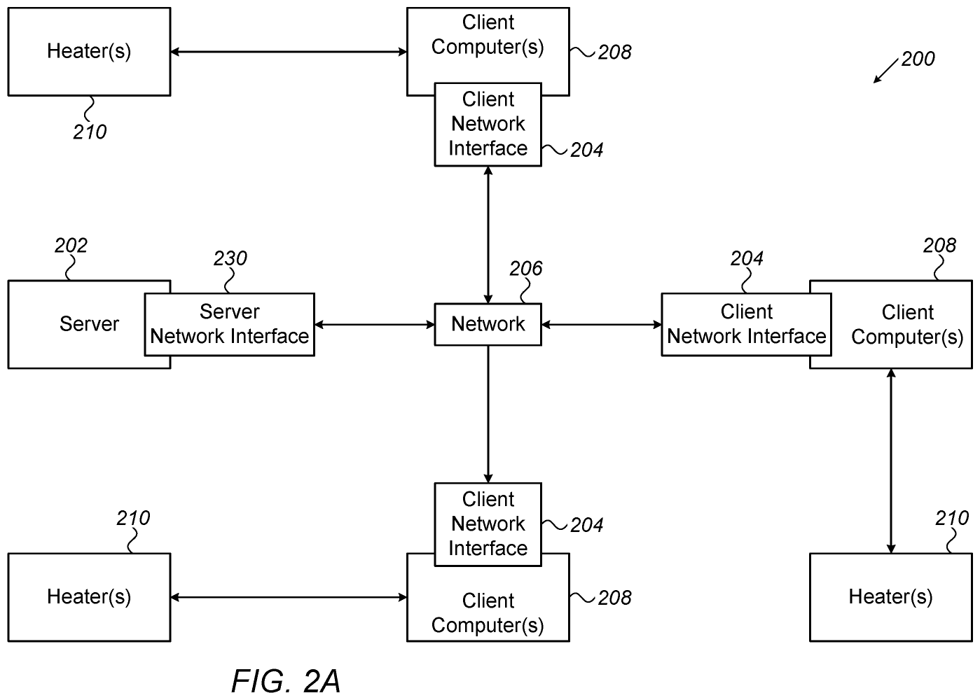

Reference is also made to FIG. 2A, which is a block diagram of a system that includes a central computing unit (e.g., server) that centrally determines heating instructions for multiple network-connected client computers each installed in association with a heater, in accordance with some embodiments of the present invention. Reference is also made to FIG. 2B, which is a block diagram depicting exemplary internal components of the server, client computers, and heater, in accordance with some embodiments of the present invention. The centralized server architecture allows for machine learning (e.g., training of a statistical classifier, decision tree learning, association rule learning, clustering, Bayesian network, support vector machines and/or other machine learning process) based on aggregation of data from the multiple client terminals. The machine learning method may be based on supervised learning, for example, heating results obtained by other heaters to improve determination of heating instructions that may relatively improve heating effectiveness of the food portion 224 (e.g., improved even heating), and/or relatively reduce total energy consumption (e.g., use less electricity to achieve a similar heating result). The machine learning method may be based on unsupervised learning, for example, determining RF patterns based on a cluster analysis. The acts of the method of FIG. 1 may be implemented by system 200 described with reference to FIGS. 2A-B.

Using server 202 located remotely from heaters 210 may improve performance of heaters 210, for example, by providing heaters 210 with the ability to improve effectiveness and/or efficiency of heating food portions 224 based on instructions provided by server 202. Server 202 may implement higher performance processing and/or memory resources (which may not be practically implemented in each heater 210) that execute food heating algorithms resulting in improved heating effectiveness and/or efficiency. Code may be centrally updated in server 202 for providing heating instructions to the connected heaters 210. The code update may be performed without input from heaters 210. By centrally updating the code, the heating effectiveness and/or efficiency of multiple heaters 210 is improved by central code updates to server 202.

Code residing on server 202 (i.e., instead of being stored on multiple heaters 210 used by end users) may be better protected from theft, hackers, counterfeiting, and/or other malicious entities.

System 200 includes one or more servers 202 (one server is illustrated for clarity, but it is understood that multiple servers may be implemented, for example, in a distributed processing system, and/or based on a cluster architecture in which each server is assigned different client computers) that perform centralized determination of heating instructions for heaters 210 installed in communication with client computers 208 in communication via a client network interface 204 with server 202 (via a server network interface 230) over a network 206 (e.g., the internet, a wireless network, a cellular network, a local area network, and/or other networks). It is noted that one set of client computer and heater is described for clarity, but it is understood that the server may communicate with multiple client computers each associated with a respective heater. Server 202 may be implemented as a hardware component (e.g., standalone computing unit), as a software component (e.g., implemented within an existing computing unit), and/or as a hardware component inserted into an existing computing unit (e.g., plug-in card, attachable unit). Server 202 may provide services to client computers 208 by providing software as a service (Saas), providing an application that may be installed on client computers 208 that communicates with server 202 (e.g., via a software interface), and/or providing functions using remote access sessions (e.g., web server accessed by a web browser).

Each client computer 208 is installed in association with a heater 210. Client computer 208 provides communication services with server 202. Heater 210 may include, for example, a microwave oven.

Heater 210 may be an existing device which is connected to server 202 via an integrated client computer 208 interface, for example, an Internet of Things (IoT) platform.

Client computer 208 may be integrated within heater 210, for example, as software installed thereon, and/or as hardware components installed within. Client computer 208 may be a standalone unit connected to heater 210, for example, using a wireless and/or wired connection. Client computer 208 may be an existing computing device (e.g., a laptop, a desktop computer, a Smartphone, a Tablet computer, a wearable computer) running customized code that is connected to heater 210, optionally using standard communication protocols (e.g., short range wireless protocol, such as BLUETOOTH®, or local wired connections such as a LAN). Client computer 208 may be a component designed to be inserted into (and optionally detachable from) heater 210, for example, a hardware card plugged into a slot in heater 210.

Client computer 208 includes one or more processors 212 for implementing code stored in a program store 214 (e.g., random access memory, a hard disk, and/or other storage devices). Client computer 208 may include a data repository 216 (e.g., a storage unit, a local memory unit, data storage on a remote server, data storage on a cloud server, a hard-drive, and an optical drive) for storing data, for example, for storing received heating instructions provided by the server. Client computer 208 may include, or be in communication with a user interface 219 that displays data to the user and/or allows a user to enter data. User interface 219 may include, for example, a display (e.g., LED or LCD) and data input (e.g., keyboard, touchscreen, barcode reader, RFID reader, etc.). Client computer 208 may be implemented as software, and/or hardware, and/or firmware, for example, as software installed on heater 210, as an external unit in communication with heater 210, and/or as a hardware card installed within heater 210. Client computer 208 may be designed as a generic modular component that is able to operate with heaters 210 regardless of the number of antennas, and/or without requiring additional RF connections between different client computers, for example, client computer 208 is implemented as software installed on a processor and memory built into or connectable to heater 210. The software may be implemented using virtual interfaces (e.g., application programming interface (API), software development kit (SDK) designed to operate with different parameters (e.g., number of antennas). The generic module client computer 208 may be easily integrated with different heaters, for example, of different sizes, different types, and/or from different manufacturers.

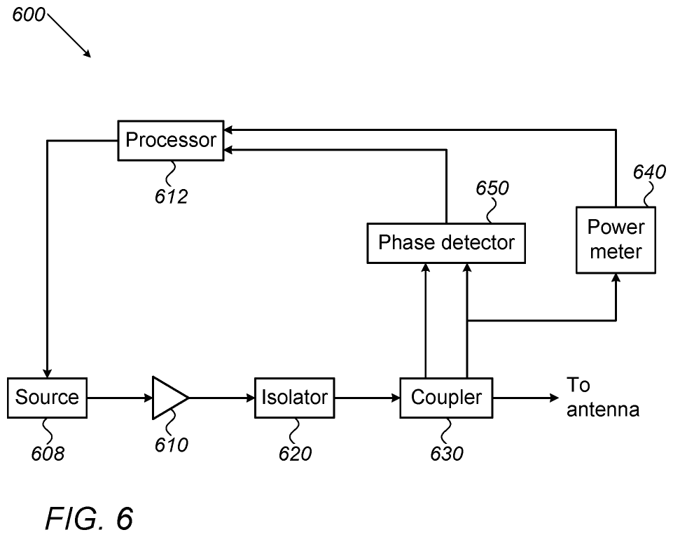

Client computer 208 may issue instructions to operate heater 210 to apply RF energy to cavity 220 of heater 210, so that the applied RF energy may heat food portion 224 inside the cavity. RF energy may be applied to cavity 220 through one or more antennas 222. The microwave frequency range generated, for example, by source 608 of FIG. 6, is between about 300 Megahertz (MHz) and 300 Gigahertz (GHz). Most heaters use frequencies allowed for industrial, scientific, and medical use, (also referred to ISM bands). Exemplary ISM bands include, for example, 433.05 MHz-434.79 MHz; 902 MHz-928 MHz, 2.4 GHz-2.5 GHz; and 5.725 GHz-5.875 GHz.

In some embodiments, client computer 208 may issue instructions to operate heater 210 to blow hot air into cavity 220 of heater 210, so that the hot air may heat food portion 224 inside the cavity. These instructions may include, for example, to what temperature to heat air inside cavity 220, at what speed to circulate the air in the cavity, through which nozzles to blow air into the cavity, etc. In some embodiments, client computer 208 may issue instructions to operate heater 210 to irradiate IR radiation into cavity 220 of heater 210, so that the IR radiation may heat food portion 224 inside the cavity. In some embodiments, client computer 208 may issue instructions to operate heater 210 to heat food portion 224 by several heat sources, e.g., hot air and RF radiation. The instructions may also include timing instructions, for example, when to use which kind of heating, e.g., start by 10 minutes of IR heating, then shut off the IR and heat by convection and RF together for 15 minutes, then turn off the RF and heat by convection only for additional 5 minutes, etc. The instructions to heat by RF may include, for example, details on what frequencies to use for the heating, at what power levels, for what time periods, when, etc.

In some embodiments, client computer 208 receives signals measured by one or more sensors 227. The signals may include reflections of RF energy applied to cavity 220. The RF energy reflected and sensed by sensors 227 may be signals transmitted into cavity 220 according to heating instructions received from the server. Alternatively or additionally, the RF energy reflected and sensed by sensors 227 may include signals transmitted for sensing purposes only. The signals may be processed (e.g., by circuitry, a processor executing code instructions, by sensor 227) by heater 210. For example, sensors 227 output raw measurements of the reflections, which are processed by heater 210 to create indications of the measurements. The indications of the measurements are transmitted to client computer 208.

In some embodiments, antenna 222 may function as a sensor. In some such embodiments, there are no separate sensors 227 for receiving RF signatures. In some embodiments, antennas 222 may be connected, to detectors, e.g., to a power meter and/or phase detector. Client computer 208 may receive from heater 210 data indicative of readings made by the detectors.

Reference is now made to FIG. 6, which is a diagrammatic illustration of an apparatus 600, in accordance with some embodiments of the present invention. Apparatus 600 is designed to heat a food portion in a cavity, for example, heater 210 of

FIG. 2A. Apparatus 600 may heat the object by feeding the cavity with RF signals of a target power level. It is noted that the target power level referred to herein is the power of signals supplied to the antenna, and not the power generated by source 608 or by power amplifier 610. It is further noted that the power amplification supplied in practice by amplifier 610 may depend upon the temperature of the amplifier and the reflections from the cavity. For example, reflections from the cavity may be reflected back into the cavity and add to the forward power. An isolator 620 may be provided between amplifier 610 and the antenna, to isolate the amplifier from reflections coming from the cavity. Isolator 620 may include, for example, two three-port circulators, each having one port connected to a 50 ohm load. The isolator may have an isolation of at least 50 dB.

Apparatus 600 may include a source 608 of RF signals. In some embodiments, source 608 may be configured to simultaneously supply RF signals of a common frequency to a plurality of output channels. However, in the embodiment depicted in FIG. 6, source 608 feeds only one output channel. The source may include, for example, a single synthesizer. Phase shifter and splitters may be omitted.

Apparatus 600 may include a phase detector 650 having two input ports and configured to measure phase differences between two signals inputted through the input ports, for example, a phase difference between a signal inputted into cavity 220 and a signal returning from cavity 220. A coupler 630 may couple to one input port a forward signal, going to the cavity, and to the other input port a backward signal, going from the cavity. Phase detector 650 may include an output port for outputting an output signal indicative of the measured phase difference, for example, the phase detector may generate a voltage output signal proportional to the measured phase difference. When a single output channel is used, one input port of the phase detector may receive a portion of the signal reflected from the cavity, and the other input port of the phase detector may receive a portion of the signal forward signal forwarded to the cavity. For example when a plurality of signals are outputted simultaneously into the cavity through a plurality of output channels, a switching mechanism may be used to direct different signals to phase detector 650. Optionally, the portion of the forward signal is split with a splitter (not shown), so that one split continues towards the phase detector, and one split is directed to an input port of a power meter.

Apparatus 600 may further include power meter 640 and processor 612. Power meter 640 may measure the power of a signal forwarded to the antenna, and processor 612 may determine the actual amplitude of the signal entering the cavity, and control source 608 so that actual power estimated to be supplied to the antennas based on readings of power meter 640 and readings of the phase detector approaches the target power level. It was found by the inventors that the readings of power meter 640 may be influenced by reflections from the cavity. For example, it was found that readings of power meter 640 may change when the s parameters of the cavity change while the control of the amplifier remains constant, therefore, processor 612 may be configured to control source 608 and/or amplifier 610 based on input from power meter 640 and phase detector 650. The phase detector may contribute the phase of the s parameters of the cavity to the calculation of power actually arriving at the antenna. The phase detector may have an output port outputting an output signal indicative of the ratio between the two input signals. This output may be used to determine the magnitude of the s parameter. Alternatively, a portion of the reflected signal may be coupled to the power meter, and the power levels of the reflected and forwarded signals (or the amplitude of the forward (or backward) signal and the ratio between them) may be used for determining the magnitude of the s parameter.

Referring now back to FIGS. 2A-B, server 202 may be, for example, a central server, a proxy server, and/or other network connected computing units. Server 202 includes a processor(s) 226, for example, a central processing unit (CPU), a graphics processing unit (GPU), field programmable gate arrays (FPGA), digital signal processor (DSP), and application specific integrated circuits (ASIC). Processor(s) 226 may include one or more processors (homogenous or heterogeneous), which may be arranged for parallel processing, as clusters and/or as one or more multi core processing units.

Server 202 includes a program store 228 storing code implementable by processor(s) 226, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Server 202 may include multiple computers (having heterogeneous or homogenous architectures), which may be arranged for distributed processing, such as in clusters. Servers 202 may be distributed at different locations within network 206, for example, at strategic points based on density of heaters.

Server 202 includes a network communication interface 230 for communicating with client computers 208 over network 206, for example, a physical interface such as a network interface card, and/or a virtual network interface implemented as code instructions. Network communication interface 230 may provide wireless and/or wired connectivity using at least one network communication protocol. Server 202 may include or be in communication with a data repository 232 for storing data and/or code implementable by processor 226, for example, storing aggregated data and/or trained classifiers (as described herein).

An exemplary implementation of heater 210 is described for example, in WIPO publication No. WO2016/166695, incorporated herein by reference in its entirety.

Heater 210 includes a signal synthesizer (e.g., a direct digital synthesizer a/k/a DDS or a voltage controlled oscillator a/k/a VCO), an amplifier, a coupler, a detector, a digital to analogue (D2A) converter, and a communication port (e.g., for communication with server 202, optionally using client computer 208). The signal synthesizer generates an RF signal that is amplified by the amplifier, and transmitted through the coupler to antenna 222. The coupler couples a portion of the signal going from the synthesizer to antenna 222 to sensor 227, which outputs a signal indicative of the amplitude and/or phase of the measured signals. The output from the detectors is digitized by the A2D, transmitted over network 206 to server 202.

At 102 an initialization signature indicative of the presence of food portion 224 in cavity 220 ready to be heated in one or more heaters 210 in communication with a respective client computer 208 is received by server 202. The initialization signature is transmitted over network 206, for example, as packets, as network messages, and/or using other network communication based implementations. The initialization signature may be transmitted, for example, triggered by the user manually pressing a “start” button on user interface 219 to start heating, or other triggers.

Food portion 224 may be, for example, frozen food to be thawed, or food to be heated. Food portion 224 may be substantially homogenous, for example, a cup of water, a piece of beef, or a bowl of soup. Food portion 224 may be substantially heterogeneous, for example, a meal including pre-cooked chicken, a side of potato salad, and a side of green beans (together on one plate). Food portion 224 may be food ready to eat (i.e., for heating). Food portion 224 may be food that is to be cooked and/or baked (i.e., not yet ready to eat, such as raw food).

In response to receiving the initialization signature, code stored in program store 218 executed by processor(s) 226 of server 202 transmits instructions back to each respective client computer 208 over network 206, for example, as packets, and/or other network messages. The instructions include instructions to transmit RF signals e.g., using antennas 222) within cavity 220 of the respective heater containing the food portion, and to measure reflections (e.g., using sensors 226) of the transmitted RF signals. The measurement of the RF signals may be processed to obtain an RF signature, or the direct measurement of the transmitted RF signals may represent the RF signature.

The RF signature may be defined according to a format, protocol, a standard, a set of rules, or other implementations. The standard format of the RF signature may allow server 202 to analyze multiple RF signatures from different client computers 208, for example, to aggregate the RF signatures, compare the RF signatures, and/or calculate data based on the RF signatures. RF signature formats may be designed for a comparison analysis, for example, by matching with a predefined RF signature, analyzed according to a set of rules, processed using signal processing methods to obtain a parameter for analysis (e.g., signal to noise ratio), and/or mapped to a result. Examples of RF signature formats may include one or more of the following data: a predefined sample length representing about 1 second or 5 seconds or 0.1 second (or other values) of measured reflections of transmitted RF signals, an average of the measured reflected RF signals, and a sum of the measured reflected RF signals (e.g., taking into account wave cancellation and/or summation).

Each respective client computer 208 transmits to server 202 over network 206 the RF signature, generated based on the measured reflections. The RF signature is associated with the received initialization signature. The association may be by client computer 208 and/or server 202, for example, the RF signature and initialization signature may be associated with each other by being stored in a database as records mapping initialization signatures to RF signatures, tagged with matching metadata, associated with each other using a created hash function, or by other methods.

At 104 server 202 receives the RF signatures transmitted from a client computers 208. Each RF signature is based on measured reflections of RF signals (measured by sensors 226) transmitted within cavity 220 of the heaters 210 associated with the client computer.

An exemplary RF signature may be implemented, for example, as a set, a list, a data array, a graph, of measurement results outputted by the sensors. Each result may be associated with the conditions at which it was obtained. For example, the measurements may be of S parameters or S matrixes, each associated with a frequency. In another example, the measurements may be of gamma parameters, each associated with a frequency, power emitted through each antenna, phase differences between signals emitted by the various antennas, and the antenna at which the gamma parameter was measured. In another example, the measurement may be of loss or DR values, and each value may be associated with a frequency, power emitted through each antenna, phase differences between signals emitted by the various antennas. The conditions may be, more generally, the excitation setups at which the measurements were taken.

Optionally, server 202 determines a hardware-type of each heater 210. The hardware-type may include, for example, the model of the heater 210, the manufacturer, and/or other design details of the heater 210, e.g., dimensions of the cavity 220, location, shape, and/or orientation of the antennas 222, 226, etc. The hardware-type may be determined, for example, by a look-up table (e.g. stored in data repository 232) that stores data of the hardware-types, transmitted by client computer 208 to server 202 (e.g., as packets and/or other network messages). The hardware type may also include information on non-RF heating systems incorporated in heater 210.

Optionally, at 106 an initialization of one or more heaters 210 is performed by server 202. The initialization may be performed, for example, periodically (e.g., at predefined intervals, such as monthly), at defined events (e.g., detection of a possible misalignment), before heating food portions (e.g., before each food portion, or before a certain number of food portions), and/or during heating of the food portion (e.g., analysis during the heating).

The initialization is performed to allow server 202 to monitor and/or control transmission of RF signals by heater 210 during the food heating and/or cooking process. For example, RF signatures received during the food heating process may be analyzed and/or compared to earlier RF signatures to determine how the food heating process is proceeding, such as whether the food is being heated as desired (e.g., according to a heating target).

Data indicative of the RF signals whose reflections were used to measure the RF signature is received by server 202 from respective client computers 208. In some embodiments, the received data is used to calculate a phase difference between at least two of the received RF signals (which may be part of the RF signature). Server 202 analyzes the phase difference (e.g., comparing the phase difference to a target phase value which may be stored in data repository 232), and may transmit instructions to adjust the RF signals (transmitted by heater 210) such that the calculated phase difference approaches the target phase value.

At 108, server 202 analyzes the RF signatures received from client computers. In some embodiments, the analysis may include a comparison between the RF signature received from one of client computers 208, and one or more of:
RF signatures received by server 202 from other client computers 208 (each in communication with a respective heater 210).
RF signature received by server 202 from the same client computer 208 earlier in the food heating process.
RF signature received by server 202 from the same client computer 208 during an earlier food heating process.
A cooking plan which may define the state of the food portion and/or RF signatures as a function of time (which may be stored in data repository 232 as a database entry, as a function, as a set of rules, and/or as a look-up table).

The comparison may be performed, for example, by a mapping function that identifies matches between RF signatures. The comparison may be performed according to statistical similarity between RF signatures to identify the most similar RF signatures, for example, calculated by a correlation function with at least 80% correlation, or at least 95% correlation, or other values.

The analyzing may include determining the current state of the food portion being heated by respective heaters 210, for example, by categorizing the respective food portion into one or multiple categories, and/or calculating a value representing the current state of the food portion (e.g., absolute value or relative value). For example, categories of the current state of the food may include: undercooked, well done, over cooked, temperature too low, uneven heating.

The classified current state of the food may be compared to the cooking plan, to determine whether the cooking is proceeding as planned, for example, is the food being or undercooked relative to the plan.

The cooking plan may be manually selected by the user (e.g., using user interface 219 and transmitted by client computer 208 to server 202), automatically selected by server 202 (e.g., according to the RF signature and/or other user provided data such as the type and/or volume and/or initial state of the food).

The cooking plan may be a generic plan suitable for multiple users cooking similar foods, and/or customized for one or more users according to taste preferences (e.g., some users might like well-done food, while others might like similar foods that are cooked less).

Alternatively or additionally, the analysis includes classifying the food portion into a heating category (from multiple heating categories each associated with a corresponding heating instruction). A heating category may be viewed as a heating goal or task, for example, defrost frozen dinner, bake bread, heat liquid, heat refrigerated meal, and cook meat. In some embodiments, the analysis may include assigning a heating value to the food portion based on the analysis (e.g., a relative, for example, heat the food by 10 degrees above the current temperature, or absolute heating value, for example, heat the food to 65 degrees Celsius). Each heating category (or heating value, or range or values) may be associated with a heating instruction. The heating category and associated RF pattern may be further associated with different types of food portions, and/or cooking plans, and/or the classification of the current state of the food portion. As discussed in additional detail with reference to block 110, a heating instruction may be determined according to the heating category and/or current state of the food and/or cooking plan.

The analysis may be performed using one or more of the following methods (e.g., stored as code instructions in program store 218 and/or data repository 32 executed by processor 226 of server 202):
A classifier trained on RF signatures obtained from multiple client computers 208 (each in communication with a respective heater).
A regression function modeling RF signatures obtained from client computers 208.
Matching the received RF signature to an entry in a look-up table storing RF signatures obtained from client computers 208.
Associating the received RF signature to one of the RF signatures obtained from client computers 208 stored in a database (e.g., in data repository 232), for example, according to statistical similarity between the RF signatures.

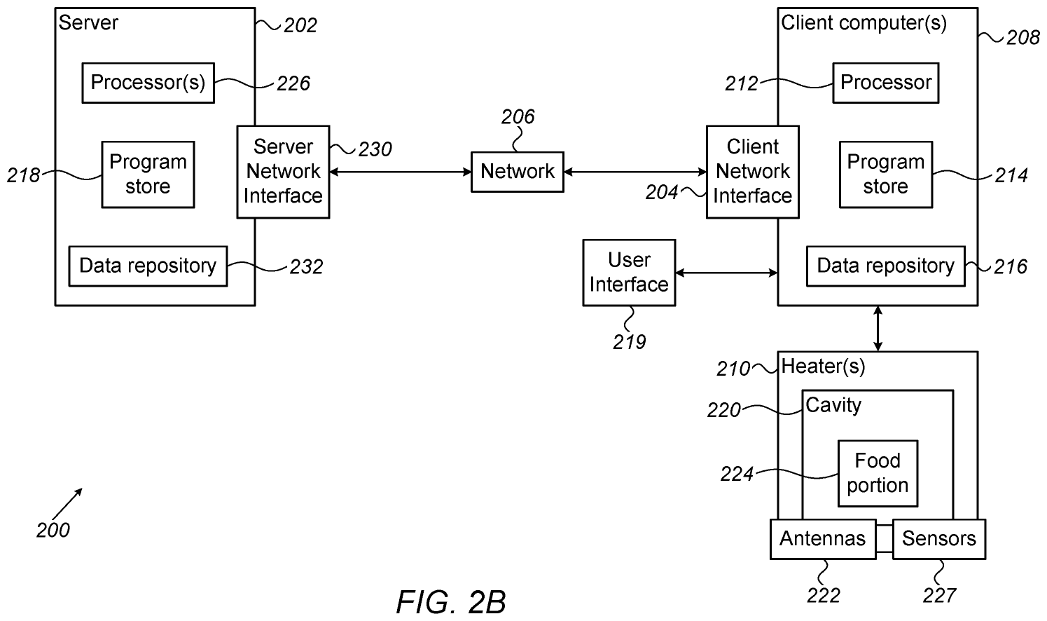

The training of the classifier and/or other data analysis methods (e.g., using data aggregated from multiple client computers 208) is described with reference to block 116 and/or FIG. 3.

At 110, server 202 determines one or more heating instructions for each heater 210 associated with respective client computer 208 (that transmitted respective RF signature). The Heating instruction is determined based on the analysis of the RF signatures. The heating instruction includes instructions (e.g., stored as signals, as code, as instructions, as a set-of-rules, as values of parameters and/or settings) to operate each respective heater 210 to heat the food portion within respective cavities 220. The heating instruction may include instructions for generating the RF signals, for example, the frequency (or frequencies), the phase, the amplitude, the duration, and/or other field affecting parameters such as excitation setups. The heating instructions may include instructions to generate RF signals (e.g., by antennas 222) that differ from one another in excitation setups, e.g., in frequency and/or phase.

The heating instruction may be determined to operate the respective heater 210 to reduce relative total energy consumption of heating the food portion during heating. For example, heating instructions which have been determined (e.g., by server 202, and/or by the manufacturer performing tests) to achieve a heating target and/or follow a cooking plan using less energy may be designated and determined for operating the respective heater 210.

The heating instruction may be determined to operate the respective heater 210 to a certain compromise between heating speed and heating uniformity. For example, some heating instructions may have been determined (e.g., by server 202, and/or by the manufacturer performing tests) to achieve excellent uniformity in 30 minutes cooking, and other heating instructions may have been determined to achieve (with the same dish) medium uniformity in 20 minutes cooking. In some embodiments, the decision which heating instructions to use may be based on uniformity/speed preferences introduced by the user, e.g., via the user interface.

The heating instruction may be determined from multiple heating instructions, for example, stored in data repository 232. The determination may be by selection from the stored heating instructions. Some heating instructions may be pre-defined (e.g., by the manufacturer). The stored heating instructions may represent heating instructions that have been previously successfully applied by different heaters 210. Optionally, the determined heating instruction improves heating effectiveness (e.g., evenness of heating the volume of the food portion, reaching a target temperature, achieving a desired cook state of the food). The heating effectiveness may be improved, for example, in comparison to heating effectiveness achievable by a locally stored standard heating program that may be executed by the client computer 208 without server input. In another example or in addition, the heating effectiveness may be improved in comparison to heating effectiveness achieved when a user manually programmed client computer 208 to operate heater 210 in a particular way, based on the user's experience in heating or a guess.

The heating instruction may be dynamically created by server 202, for example, based on code implementing a heating algorithm. The dynamically created heating instruction may be a customized set of instructions for the respective heaters 210 based on a generic heating pattern generating function. For example, the heating instruction may include values for parameters of a generic heating pattern generating function. The same generic heating pattern generating function may produce customized instructions based on the customized values of the function parameters.

The heating instruction may be determined according to the analyzed RF signature. For example, a mapping function, statistical classifier (or other method) may map the analyzed RF signature to a respective heating instruction. The mapping may be performed according to the determined current state of the food, according to the cooking plan, heating category, according to the hardware-type of the heater 210, and/or other parameters. The heating instruction may be dynamically created by a function using the input of the RF signature, the current state of the food, the cooking plan, the determined heating category, the determined hardware-type, and/or other parameters.

Optionally, the heating instruction includes parameters defining when to transmit the RF energy to heat the food, for example, length of time of transmission, length of non-transmission, and frequency of repeating transmission followed by no transmission.

Optionally, when heater 210 includes or is in communication with a non-RF heating element (optionally a convection heating element, an IR heating element, an induction heater, etc.), one or more non-RF heating instructions may be determined by server 202 for application by the non-RF heating element. The non-RF heating instruction may be associated with the determined RF related heating instruction, for example, included as a set of instructions for implementation by client computer 208. The non-RF heating instruction may include, for example, heating temperature, time, and timing. The timing may include when, during the cooking process, non-RF heating is to be on, and when it is to be off.

At 112, server 202 transmits over network 206 to each client computer 208 (that transmitted the RF signature), the respective heating instruction(s) determined for the respective heater 210. The determined heating instructions may be transmitted, for example, as packets and/or network messages using a suitable network communication protocol.

Each determined heating instruction(s) may include instructions to generate RF signals and transmit the RF signals to the respective food portions 224 (located within cavity 220) using heating antennas 222 of the respective heater 210.

At 114, one or more blocks 104-112 are iterated. The iterations may be performed by server 202 to control and/or monitor the heating of the food portion by respective client computers 208. The controlling may be performed repeatedly during the cooking process of the food portion. The controlling may be performed continuously, at predefined time intervals, in response to receiving RF signatures from client computers 208, and/or according to events. The controlling may be performed in real-time.

The iterations may be performed to monitor and/or control heating of the food portion according to a determined heating target and/or according to a determined cooking plan.

Server 202 controls heating of respective food portions 224 by receiving data indicative of results of measurements of reflections of the determined heating instruction transmitted to cavity 220 of the heater 210. The data may be received as RF signature or other RF based data as described with reference to block 104.

Server 202 analyzes the received data, for example, as described with reference to block 108. The received data may be compared to the previously received historical data from the same heater 210 (e.g., during the current heating process and/or another heating process), to data received from other heaters 210 (e.g., performing similar heating processes), and/or to stored data representing models of heating processes and/or heating targets.

Server 202 may adjust the Heating instruction according to results of the analyzing. The adjustment may be performed when the current heating instruction appears to deviate from the heating target and/or the cooking plan. The adjusted heating instruction may be determined to achieve the heating target and/or cooking plan. The existing heating instruction may be adjusted (e.g., increase or decrease in intensity or amplitude, change in RF signal patterns), and/or a new heating instruction may be determined to generate the adjusted heating pattern, for example, as described with reference to block 110.

In some embodiments, the adjusted heating pattern (and/or instructions to generate RF signals according to the adjust heating pattern) is transmitted from server 202 to client computer 208 to operate heater 210 to generate RF signals using antennas 222 to heat food portion 224 within cavity 220, according to the adjusted heating pattern, for example, as described with reference to block 112.

The instructions to generate RF signals according to the adjusted heating may represent a predefined period of time. During or upon expiration of the period of time, blocks 104-112 may be repeated.

Optionally, at 116, data is collected from multiple client computers 208 and aggregated by server 202. The aggregated data may be used as part of a machine learning process for application to future food portions by learning from current determination of heating instructions according to RF signatures. The aggregation of the data may be used to control the current heating process of the food portion, by learning from other client computers operating other heaters to heat similar food portions. The aggregated data may be used to train a classifier, which may be applied, for example, in block 108 of FIG. 1 to analyze the RF signatures and/or to determine the heating instruction according to the RF signature.

Reference is now made to FIG. 3, which is a flowchart of a computer-implemented method that trains a classifier to determine the heating instruction for a heater, in accordance with some embodiments of the present invention. The acts of the method of FIG. 3 may be implemented by instruction code stored in program store 218 executed by processor 226 of server 202.

As used herein, the term classifier is broadly used, to include one or more machine learning methods, which receive RF signature (and/or other values) as input and provides a heating instruction (and/or other values as described herein) as output. The classifier may be implemented as, for example, kernel methods, support vector machine, support vector regression, a look-up table, a regression function or set of regression functions, a statistical classifier that maps input to an output category, a deterministic classifier, a hash-table, a mapping function, and/or other methods.

At 302, server 202 receives from a client computer 208, an indication of whether a desired heating effect is reached by the heating instruction determined for the respective heater 210.

The indication may be manually entered by the user, for example, using user interface 219. For example, the user may press a YES (or LIKE) or NO (or DISLIKE) button on a graphical user interface to enter data with respect to whether or not the user is happy with the heating results. The user-inputted indication may be used by the classifier. For example, the information that the heating instructions applied gave satisfactory results with a certain user may increase the probability that the same heating instruction will be determined by the classifier next time the same user is heating the same dish.

An incentive program may be created to encourage users to enter data. For example, users that enter data for every cooking session for a month may receive a month of free server 202 services. Employees in corporations and businesses may be instructed to enter data when using a common heater 210 (e.g., located in the employee kitchen).

At 306, server 202 receives RF signature data from the client computers. The received data may be stored in data repository 232.

Server 202 may receive one or multiple data items, including:
The association between the RF signature data and an indication of a current state of the food portion. The current state of the food may be manually entered by the user using user interface 219 (e.g., pressing buttons, selecting value on a scale, and/or other methods, for example, based on the user manually inspecting the food). Exemplary current states of the food may include, for example: frozen, thawed, raw, undercooked, cooked right, overcooked, and unevenly cooked. The current state of the food may include a type of food, for example, meat, chicken, fish, eggs, water, cake, bread, vegetables. The current state of the food may include a weight, a volume, a shape, and/or a size of food. The current state of the food portion may include the temperature and/or phase state of the food, for example, frozen state, cold state (e.g., removed from fridge), and room temperature state. The current state of the food portion may include the eatability state of the food, for example, raw state (e.g., meat), ingredients ready for baking state, and ready to eat (e.g., after warming). One or more of these parameters of the current state of the food may be estimated, measured, and/or manually entered.
Test results of a self-test executed by one or more of client computers 208 to test the respective heater 210. Heaters 210 may deteriorate at different rates or unexpectedly. Self-tests may be designed to identify unexpected deterioration or deterioration rate. For example, the self-test may include transmitting a predefined RF signal within cavity 220 using antennas 222, recording the reflections using sensors 227, and comparing the actual measured values to expected values. The test results may be grouped according to hardware-types of heaters. Server 202 may analyze the test results according to the grouped hardware-type of heaters, and compare it to test results obtained from other heaters of the same hardware-type, or to test results obtained from the very same heater at an earlier occasion. Such comparisons may be used to determine service requirements. For example, when the measured reflection values are significantly different from expected reflection values, server 202 may transmit instructions to display on user interface 219 (e.g., on a display) a message, for example: call for repair, reset heating device, clean cavity, or other messages.
Adjusted heating patterns and respective measured reflections of the applied RF heating. The heating pattern determined by the server may be represented as a set of instructions, for example, implemented as compiled code, values to be received by a function, a script, or a non-compiled program. The adjusted heating patterns and respective measured reflections may be used to update a trained classifier that adjusts heating instructions based on received measured reflections.

At 308, server 202 associates with each received RF signature data, the heating instruction(s) previously transmitted from server 202 to operate the respective heater 210, and/or associate an indication of whether the desired heating effect is reached using the determined heating instruction. The indication whether the desired heating effect is reached may be manually provided.

At 310, server 202 trains and/or updates a classifier based on the aggregated and/or associated data. The classifier may be trained using as input the association between received RF signature, heating pattern, and heating effectively. The output of the classifier may be a rule or associating heating patterns to RF signatures that brings about the most effective heating. An existing classifier may be updated with additional data, for example, by recalculating the classifier using the additional data.

The classifier may be trained using data for which the desired heating effect is reached as a desired output result. The classifier may be trained using data for which the desired heating effect is not reached as a non-desired output result. The outcome associated with the data may improve the ability of the classifier to achieve the desired heating effect.

The classifier may be trained using additional data which may be received from client computers 208, optionally the current state of the food portion. The classifier may be trained to output the heating instruction based on the current state of the food (provided as input to the classifier). Alternatively or additionally, a statistical classier may be trained to output the category (and/or value) representing the current state of the food, by providing the RF signature as input.

The trained classifier receives the RF signature data as input and performs the determining of the heating instruction(s). The determining is performed to achieve the desired heating effects (e.g., as described with reference to block 110).

The trained classifier may be stored in data repository 232.

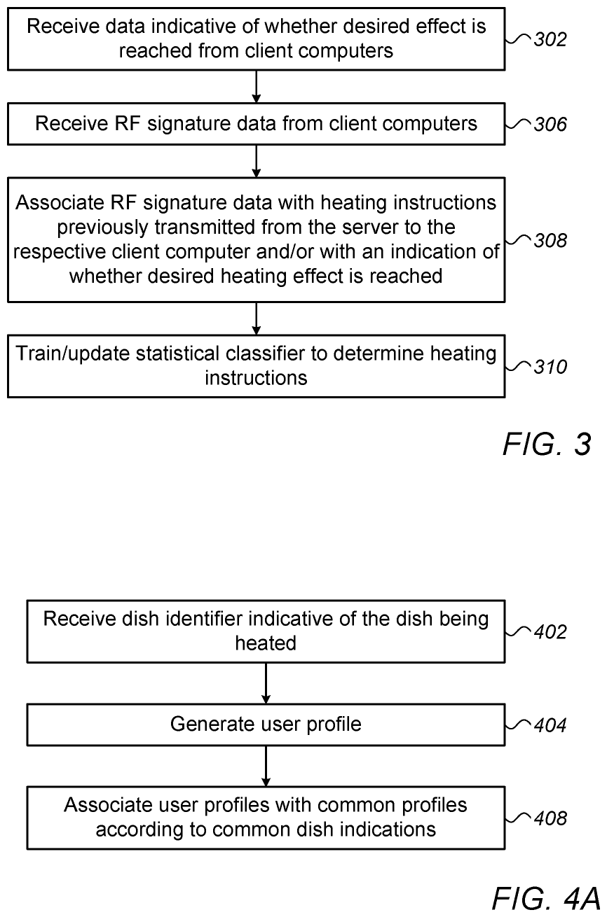

Reference is now made to FIG. 4A, which is a flowchart of a computer-implemented method that aggregates data from multiple users, in accordance with some embodiments of the present invention. The aggregated data is based on personal preferences of users. The aggregated data may be used to create a user profile for each user, which may include the dishes the user likes to heat, and/or to the habit of each user. The acts of the method of FIG. 4A may be implemented by instruction code stored in program store 218 executed by processor 226 of server 202. The acts of the method of FIG. 4A may be triggered, for example, by server 202 receiving the initialization signature (e.g., as described with reference to block 102 of FIG. 1) and/or at other events during the heating process described with reference to FIG. 1. At 402, server 202 receives from a client computer 208 a dish identifier indicative of a dish being heated by the respective heater 210, being used by a respective user. The dish may include food of multiple types, for example, arranged together on a plate. The dish may include multiple ingredients, for example, chicken stuffed with rice. The dish may include, for example, a frozen dinner, heat-and-eat food product, raw ingredients ready to be baked or cooked, etc.

The dish identifier may be manually entered by a user, and/or automatically determined. The user may enter the dish identifier, for example, using user interface 218, e.g., selecting from a list of dishes, typing in the dish identifier, and/or scanning a barcode or QR code of packaging of the dish). Automatic determination of the dish may be carried out, e.g., by server 202 analyzing RF signature data. A dish identifier may be indicative of any one or more of following: the type of food included in the dish, the dish shape, the dish size, the dish weight, the dish temperature, the dish frozen state (e.g., completely frozen, partly frozen, completely thawed).

Server 202 may receive the dish identifier from different client computers 208, optionally each time the respective user of the client computer is heating a dish in the respective heater 210.

At 404 a user profile (as explained below) is generated or, if already exists, updated by server 202. The user profile is updated by associating it with the dish identifier, and optionally by the weekday and time at which the dish is being cooked by the user. The user profile may be generated and updated based on data from the same user cooking similar (or the same) dish in multiple heating sessions.

The user profile may be stored in data repository 232, for example, as a database entry, as a set of values of parameters, as code, as text, as a script, or other implementations.

As used herein, a user profile may include user characteristics, dish identifiers of dishes the user cooks, one or more of cooking parameters suitable for each dish the user cooks, and/or cooking habits associated with the dish. Examples of user characteristics may include: geographical location of the client computer that the user uses. Examples of cooking parameters include: a total target cooking time for the dish., a cooking power suitable for the dish (e.g., full power, half power, 200 Watt, 500 Watt), a cooking algorithm suitable for the dish (for example, an algorithm for selecting controllable field affecting parameters, such as frequencies and phase differences, based on DR values). One or more of the cooking parameters may be based on experience in reaching a desired heating effect by the user and/or by other users, for example, other users of similar user characteristics. Examples of cooking habits may include: a time of day when the dish is cooked most often, a day of the week when the dish is cooked most often, a holiday when the dish is cooked by the user more often than in other days of the year, a date when the dish type is cooked more than in others, and/or a geographic location where the dish is typically cooked. The user profile may include cooking habits of the user and/or of other users of similar user characteristics.

Server 202 may analyze cooking parameters from multiple user profiles of different users. The analysis may be used to determine heating instructions, for example, the server may use the data in training of the classifier that determines the heating instructions. The classifier may be trained to determine the heating instruction for a certain user based on heating instructions that other users used for cooking similar dishes. The classifier may be trained to determine the heating instruction for a certain user based on heating instructions used by other users having similar user profiles, for example, other users located in the same geographical zone as the certain user.

Server 202 may analyze the cooking habits from multiple user profiles for use in determining heating instructions. For example, the heating instruction may be determined based on geographical location of the heater 210. For example, according to the analysis of the user profiles, the same or similar dish may be heated differently for users located in the United States than for users located in France, since people in the United States may have different taste preference than people in France.

The user profile is created and/or updated for each user. The user profile may be stored in data repository 232, for example, as a record, as a database entry, as code, as a script, as values associated with parameters, or other implementations. The user profile may include the dish identifiers representing the dishes that the user has heated, for example, the dishes that the user heats frequently. In this context, “frequently” may be defined absolutely (e.g., more than once a week), or in relation to the user (e.g., the five dishes heated most frequently by the user), or in relation to other users (e.g., the dishes, for which the user cooks more frequently than 80% of the other users that cook the same dish). The user profile may include cooking parameters for the dish types included in the user profile, for example, a user profile may include a plurality of dish identifiers, and cooking parameters associated with each of them.

In some embodiments, for example, in embodiments where the heater is installed in a restaurant or other setup where one heater may be used by multiple users, the users may identify themselves, for example, by entering a name and/or password using user interface 218, for example, before starting a new heating process. The user profile may be associated with the users themselves, such that the same user using different client computers 208 may log in with the assigned name and/or password. Alternatively, the user profile may be associated with the client computer 208 (which may have one or multiple users), which may not necessarily require a name and/or password for identification. The user profile may be associated with a digital ID of the client computer 208 that may be automatically obtained by server 202 (i.e., without the user entering the ID), for example, a network address.

At 408 server 202 associates different user profiles with common profiles according to dish indications that are common between the set of dish indications of the user profiles. The common profile may be generated as a union of the individual user profiles having at least a predetermined number of dish identifiers (e.g., one dish identifier) in common. The common profile may be calculated according to a set of rules to include user profiles having dish indications in common according to the set of rules, for example, at least 2 dishes in common with each other, at least 2 dishes in common with different other users, or other sets of rules. For example, for a first user profile including macaroni and cheese and pizza, and a second user profile including macaroni and cheese and cheese lasagna, the common profile may include macaroni and cheese, pizza, and cheese lasagna.

Optionally, server 202 clusters different user profiles into common profiles according to dish identifiers that are common between the user profiles. The common profile may be generated as a union (or according to a set of rules) based on user profiles having in their profiles a similar dish identifiers associated with similar cooking parameters (which may be identified as similar according to a similarity requirement, for example, at least an 80% match). For example, user profiles including well done meat as a cooking target may be clustered together in a common profile.

Alternatively or additionally, server 202 may cluster user profiles into common profiles based on other parameters stored in the user profile, for example, cooking parameters, geographical location, gender of users, and age of users. For example, common profiles may be created for users located with the same geographical location, and/or are of the same age. For example, the common profile may store dish identifiers that are preferred by retired Italians, or college age Americans.

The mapping between individual user profiles and the common profile may be stored, for example, by a mapping function, links, a look-up table, or other implementations in data repository 232. The common profile may store values or links to the individual user profiles, for example, as a database entry, or within a portion of a data table.

Reference is now made to FIG. 4B, which is a flowchart of a computer-implemented method that provides personal recommendations to a user based on data aggregated from multiple users, in accordance with some embodiments of the present invention. The aggregated data may be performed using the method described with reference to FIG. 4A. The acts of the method of FIG. 4B may be implemented by instruction code stored in program store 218 executed by processor 226 of server 202. The acts of the method of FIG. 4B may be triggered, for example, by server 202 receiving the initialization signature (e.g., as described with reference to block 102 of FIG. 1) and/or at other events during the heating process described with reference to FIG. 1.

In a nutshell, the method of FIG. 4B provides recommendation to a certain user to prepare a dish of a certain type. The dish may be recommended based on dishes that other users cook frequently. In some embodiments, the other users are users that have profiles similar to the profile of the certain user, and/or users associated to a same common profile.

At 410, server 202 receives an indication that a user is about to heat a dish, or is currently heating a dish. The user is associated with a user profile. For example, the user may be identified according to the client computer associated with the heater the user is using, or the user may enter a username in a GUI presented on a display associated with the client computer. Server 202 may identify the user profile based on the indication of the user, for example, by using the username to look-up the user profile stored in a database using a look-up table.

At 411, Server 202 receives an indication of a dish identifier of a dish about to be heated by the certain user having the certain user profile. The dish identifier may be entered, for example, as described in relation to FIG. 4A, box 402.

At 412, server 202 identifies the common profile associated with the certain user, for example, using a mapping function, performing a look-up procedure in a database, and/or other methods.

At 413, server 202 accesses the common profile to obtain one or more heating instructions for the dish the user is about to heat. The heating instructions may be presented for selection by the user, for example, presented on the GUI as a list or icons for the user to select from. The heating instructions may be presented based on habits of other users of the common profile. For example, the user may be cooking lasagna in the morning for breakfast. The heating instructions available may include: heating instructions used by Italians to cook lasagna, heating instructions used by American college students to cook lasagna for breakfast, and heating instructions used by friends of the user for cooking lasagna for a holiday. Alternatively or additionally, the heating instruction is determined based on a set-of-rules that the user may enter, for example, select the most common heating instruction used by users of the common profile.

At 414, server 202 accesses the common profile to obtain one or more other dish identifiers. Optionally, the obtained dish identifier is present in the common profile, but absent from the profile of the certain user. The other dish indications represent dishes that other similar users included within the common profile like to heat, and which may be of interest to the certain user.

At 416, server 202 transmits the obtained dish identifier to client computer 208 of the certain user. The obtained dish identifier is used as instructions to present on user interface 218 (e.g., on a display and/or touch screen), for example, an image of the dish associated by the obtained dish indication and/or a textual description of the dish. The dish associated with the obtained dish identifier is referred hereinafter as “the obtained dish”. The user may use a GUI on user interface 218 to obtain additional information on the obtained dish, for example, a coupon to purchase the dish (e.g., when pre-packaged), a link to purchase a book of recipes including the new dish, and/or an advertisement of a supermarket selling the dish.

The obtained dish identifier may be transmitted for presentation of the obtained dish on another display of the user using the client computer, for example, as an email to an email account of the user, as an animation for presentation on the smartphone of the user, and/or as a webpage that is automatically opened on a tablet computer of the user. The client computer may forward the dish identifier to the other display, and/or the server may transmit the obtained dish identifier directly to the other display (e.g., according to communication addresses stored on the server).

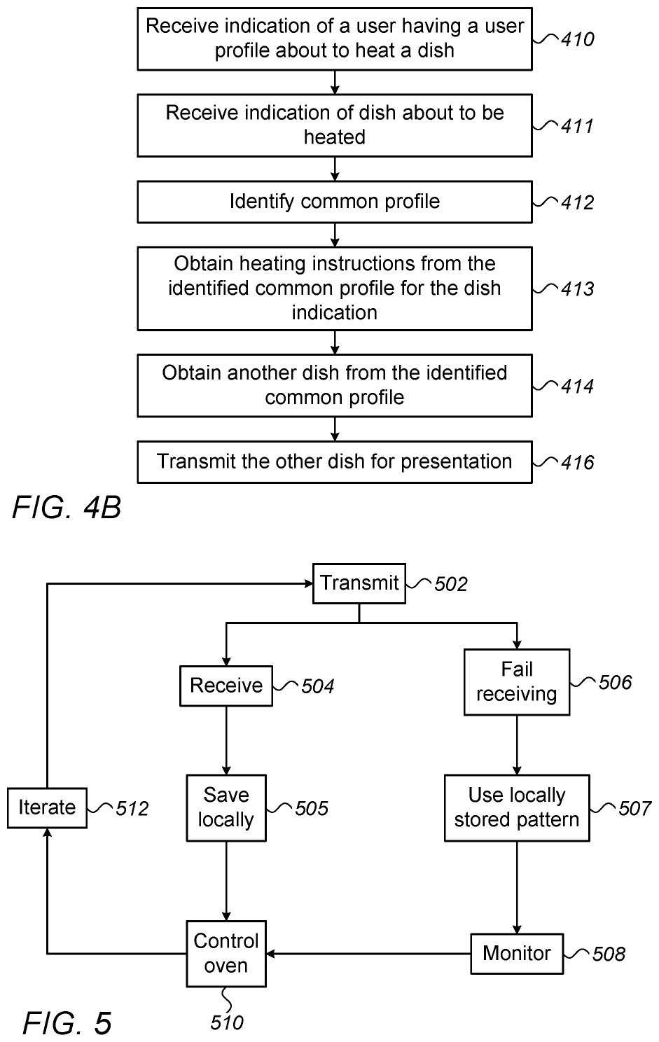

Reference is now made to FIG. 5, which is a flowchart of a computer-implemented method for monitor and/or control of heating food portions in a heater 210 installed in communication with client computer 208 in communication with server 202 over a network 206, in accordance with some embodiments of the present invention. The acts of the method of FIG. 5 represent the client-side corresponding to the method described with reference to FIGS. 2A-B. The acts of the method of FIG. 5 may be implemented by instruction code stored in program store 214 executed by processor 212 of client computer 208. The method of FIG. 5 is described with reference to one of the client computers 208, but is to be understood as being able to be implemented by each client computer 208 in communication with serer 202.

At 502, client computer 208 transmits to server 202 over network 206, an RF signature. The RF signature is based on measured reflections of RF signals transmitted by antennas 222 within cavity 220 of associated heater 210 containing food portion 224. The RF signature is received by server 202, for example, as described with reference to block 104 of FIG. 1.

At 504, client computer 208 receives from server 202 heating instruction(s) determined based on analysis of the RF signature (e.g., determined by server 202 as described with reference to block 110 of FIG. 1). The heating instruction includes instructions to generate RF signals and transmit the RF signals using antennas 222 to cavity 220 of the heater 210. The heating instruction is used to operate the associated heater 210 to heat food portion 224, as described with reference to block 510.

At 505, the received heating instruction is locally stored by client computer 208 in program store 214 and/or data repository 216.

Alternatively to 504, at 506 client computer 208 detects a failure to receive an instruction message from server 202 defining the heating instruction for an upcoming period of time. The failure may be detected based on an expiration of a predefined time threshold, for example, 5 seconds, 10 seconds, or 20 seconds.

At 507, client computer 208 may continue to apply the previously received heating instruction to cavity 220 or a default heating pattern, e.g., in case the failure is in the beginning of the heating. The default may depend upon the dish-type, and the client computer may prompt the user to enter information on the dish-type.

At 508, client computer 208 may monitor for reception of the instruction message (e.g., the instruction message may have been lost and/or delayed in network 206, and/or re-transmitted by server 202). The monitoring may continue for a predefined time requirement during which the previously received heating instruction or the default heating instruction is applied. Upon expiration of the predefined time requirement, client computer 208 may issue instructions to heater 210 to apply another heating instruction according to a locally stored Heating instruction (e.g., stored in data repository 216). Multiple heating instructions may be stored, for example, as a series where each series represents a default for a certain dish type. During heating, one pattern may be used at a time. For example, one heating instruction may be used for thawing a frozen dish, and a second heating pattern may be used for cooking the thawed dish, after the first heating pattern was used, and the dish has been thawed.

At 510, (following 504 or 508 when the message arrives) client computer 208 issues instruction (or forwards received instructions) to control heater 210 according to the received heating instruction, as described herein.

At 512, one or more blocks 502-510 are iterated during the control and/or monitoring process described with reference to block 114 of FIG. 1.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant heaters, client computers, and servers will be developed and the scope of the terms heaters, client computers, and servers are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”. The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A computer-implemented method for monitoring and control of heating food portions in a plurality of heaters, each installed in communication with a respective client computer, wherein the client computers are in communication with a same server, the method comprising:
receiving at the server, from the client computers, RF signatures, each RF signature being based on measured reflections of a plurality of RF signals transmitted within a cavity of one of the heaters, the cavity containing therein a food portion to be heated by the respective heater;
analyzing, by the server, the RF signatures received from the client computers;
determining for each heater, by the server and based on the analysis of the RF signatures, at least one heating instruction to operate each heater to heat the food portion therein; and
transmitting, from the server to each of the client computers, the respective at least one heating instruction determined for the respective heater.

2. The method of claim 1, wherein the heaters are dielectric heaters.

3. The method of claim 2, wherein each heating instruction comprises an instruction to generate a plurality of RF signals and transmit the plurality of RF signals to the food portions using heating antennas of the dielectric heater.

4. The method of claim 3, wherein each of the plurality of RF signals has a power of at least 100 W.

5. The method of claim 1, wherein
the analysis comprises comparing the RF signature with RF signatures received by the server from a plurality of client computers, each in communication with a respective heater.

6. The method of claim 1, wherein determining comprises selecting the at least one heating instruction from a plurality of heating instructions.

7. The method of claim 1, wherein analyzing is performed by a member selected from the group consisting of:
a classifier trained on RF signatures obtained by a plurality of client computers, each in communication with a respective heater;
a regression function modeling RF signatures obtained by a plurality of client computers, each in communication with a respective heater;
matching the received RF signature to an entry in a look-up table storing RF signatures obtained by the plurality of client computers; and
associating the received RF signature to one of the RF signatures stored in a database according to statistical similarity, wherein the RF signatures stored in the database are obtained by the plurality of client computers.

8. The method of claim 1, wherein determining comprises determining at least one heating instruction to operate the heater to at least one of:
reduce relative total energy consumption of heating the food portion during heating; and
improve heating effectiveness of the food portion during heating in comparison to a locally stored standard heating program executed by the client computer without server input.

9. The method of claim 3, wherein the instructions to generate a plurality of RF signals include instructions to generate RF signals that differ from one another in at least one of frequency and phase.

10. The method of claim 1, wherein analyzing comprises:
applying a classifier to the RF signature to classify the food portion into a heating category from a plurality of heating categories each associated with a corresponding heating instruction; and
selecting a heating instruction for the food portion based on the classification.

11. The method of claim 1, further comprising:
controlling by the server the heating of the food portions, by:
iterating the receiving and the analyzing, and wherein determining comprises receiving data indicative of results of measurements of reflections of RF signals;
adjusting the at least one heating instruction according to results of the analyzing to generate an adjusted heating instruction; and
transmitting the adjusted heating instruction to the client computer to operate the heater according to the adjusted heating instruction.

12. The method of claim 6, further comprising:
controlling by the server the heating of the food portions, by:
iterating the receiving and the analyzing, and wherein determining comprises receiving data indicative of results of measurements of reflections of the RF;
adjusting the heating instruction according to results of the analyzing to generate an adjusted heating pattern; and
transmitting the adjusted heating pattern to the client computer to operate the heater to generate RF signals according to the adjusted heating pattern.

13. The method of claim 11, wherein the heating instructions adjusted according to a heating target.

14. The method of claim 11, wherein the controlling is performed in real-time.

15. The method of claim 12, further comprising transmitting instructions to generate RF signals according to the adjusted heating pattern for a predefined period of time, and repeating the controlling upon expiration of the predefined period of time.

16. The method of claim 11, wherein the controlling is repeatedly performed during a cooking process of the food portion.

17. The method of claim 1, further comprising:
receiving at the server, from each of the client computers, an indication of whether a desired heating effect is reached;
associating with each of the received RF signature data, at least one heating instruction sent from the server to operate the respective heater, and an associated indication of whether the desired heating effect is reached using the at least one heating instruction; and
training a classifier that performs the determining of the at least one heating instruction according to the indication of desired heating effects.

18. The method of claim 17, further comprising training the classifier using RF signature data as input into the classifier and corresponding applied heating instructions as output of the classifier.

19. The method of claim 1, further comprising:
aggregating, at the server, RF signature data and an indication of a current state of the food portion received from at least some of the client computers; and
training a classifier to perform the analysis using the RF signature data representing input into the classifier and the current state of the food portion as a categorization representing output by the classifier.

20. The method of claim 19, wherein the current state of the food comprises a type of food.

21. The method of claim 1, further comprising:
aggregating, at the server, test results of a self-test executed by at least one of the client computers to test the respective heater;
grouping the test results according to types of heaters; and
analyzing the test results according to the grouped types of heaters to determine service requirements.

22. The method of claim 11, further comprising:
aggregating adjusted heating patterns and respective measured reflections of the applied heating instructions, at the server, from the plurality of client computers associated with respective heaters, to update a trained classifier that adjusts at least one heating instruction based on received measured reflections.

23. The method of claim 1, further comprising:
determining a hardware-type of each heater;
receiving RF signature data from at least one of each heater; and
determining the at least one Heating instruction for each heater according to the hardware-type of the heater and the received RF signature data aggregated from the respective heater.

24. The method of claim 1, further comprising:
receiving, at the server, from each of a plurality of client computers, a dish indication, indicative of a dish being heated by a respective heater in communication with a respective client computer, by a respective user using the respective heater;
creating a user profile for each user based on a set of dish indications; and
associating different user profiles into common profiles according to dish indications that are common across the set of dish indications of the user profiles.

25. The method of claim 24, further comprising:
receiving, at the server, an indication that a new dis is heated by a certain user of a certain user profile;
identifying the common profile associated with the certain user;
accessing the common profile to obtain another at least one dish; and
transmitting, for presentation to the client computer, the obtained another at least one dish.

26. The method of claim 24, further comprising:
determining at least one cooking parameter for the dish indication;
including the at least one cooking parameter determined for the dish indication in the user profile; and
wherein associating comprises associating different user profiles with common profiles according to cooking parameters of dish indications that are common between user profiles.

27. The method of claim 26, wherein the at least one cooking parameter includes one or more members selected from the group consisting of: a total cooking time of the dish indication, a cooking temperature of the dish indication, a time of day when the dish indication is cooked, a day of the week when the dish indication is cooked, a holiday when the dish indication is cooked, a date when the dish indication is cooked, and a geographic location where the dish indication is cooked.

28. The method of claim 1, wherein the heater includes or is in communication with a non-RF heating element; wherein determining further comprises: determining at least one non-RF heating instruction for application by the non-RF heating element, in association with the determined RF heating instruction.

29. The method of claim 28, wherein the non-RF heating instructions includes instructions to use convection heating.

30. The method of claim 1, further comprising performing an initialization by:
receiving, at the server, data indicative of the RF signals whose reflections were used to measure the RF signature, the RF signals including data for calculating a phase difference between at least two of the RF signals;
calculating the phase difference; and
transmitting instructions to adjust the RF signals such that the calculated phase difference approaches a target phase value.

31. The method of claim 1, further comprising, before the act of receiving RF signature data:
receiving, at the server, from the client computer, an initialization signature indicative of the presence of a food portion ready to be heated in the heater in communication with the client computer;
transmitting, from the server to the client computer, instructions to:
measure reflections of a plurality of RF signals transmitted within a cavity of the heater, the cavity containing therein the food portion;
send to the server an RF signature based on the reflections measured; and
associating the RF signature with the received initialization signature.

32. A computer-implemented method for monitoring and control of heating food portions in a heater installed in communication with a client computer, wherein the client computer is in communication with a server, the method comprising:
transmitting, to the server, from the client computer, an RF signature based on measured reflections of a plurality of RF signals transmitted within a cavity of the heater, the cavity containing therein the food portion;
receiving, from the server, at least one heating instruction determined by the server based on analysis of the RF signature, to operate the heater to heat the food portion, the at least one heating instruction comprising instructions to generate a plurality of RF signals and transmit the plurality of RF signals to a cavity of the heater; and
controlling the heater according to the received at least one heating instruction.

33. The method of claim 32, further comprising:
detecting, by the client computer, a failure to receive an instruction message from the server defining the heating instruction for an upcoming period of time; and
continuing, by the client computer, to control the heater to heat according to the previously received heating instruction.

34. The method of claim 33, further comprising:
monitoring, by the client computer, for reception of the instruction message for a predefined time requirement; and
upon expiration of the predefined time requirement, applying a heating instruction according to instructions locally stored on a storage medium of the client computer of the heater.

35. A server for monitoring and control of heating food portions in a plurality of heaters, each installed in communication with a respective client computer, each food portion contained within a cavity of the respective heater, the server comprising:
a communication interface for communicating using a network with the plurality of client computers;
a program store storing code; and
a processor coupled to the communication interface and the program store for implementing the stored code, the code comprising:
instructions to:
receive RF signatures from each of the client computers, each RF signature being based on measured reflections of a plurality of RF signals transmitted within each respective cavity;
analyze each RF signature;
determine, based on the analysis of the RF signatures, at least one heating instruction to operate the respective heater to heat the respective food portion; and
transmit each determined at least one heating instruction to the respective client computer,
wherein the determined at least one heating instruction comprises instructions to generate a plurality of RF signals and transmit the plurality of RF signals to a cavity of the respective heater.

36. The server of claim 35, wherein the determined at least one heating instruction comprises instructions to generate a plurality of RF signals and transmit the plurality of RF signals to a cavity of the respective heater.

37. A computer-implemented method for monitoring and control of heating food portions in a heater installed in communication with a client computer, wherein the client computer is in communication with a server, the method comprising:
receiving at the server, from the client computer, an RF signature based on measured reflections of a plurality of RF signals transmitted within a cavity of the heater, the cavity containing therein the food portion;
analyzing, by the server, the RF signature received from the client computer;
determining by the server, based on the analysis of the RF signatures, at least one heating instruction to operate the heater to heat the food portion; and
transmitting, from the server to the client computer, the determined at least one heating instruction.

38. The method of claim 37, wherein the determined at least one heating instruction comprising instructions to generate a plurality of RF signals and transmit the plurality of RF signals to the food portions using heating antennas of the heater.

39. A method according to claim 37, wherein the heater is one of a plurality heaters, each installed in communication with a respective client computer, and all the client computers are in communication with the server.
